(19) United States
(12) Patent Application Publication
(10) Pub. No.: US 2003/0163536 A1
(43) Pub. Date: Aug. 28, 2003

(54) Message communications addressing system

(75) Inventor: Richard J. Pettine JR., West Chester, PA (US)

Correspondence Address: Elsa Keller, Intellectual Property Department, Siemens Corporation, 186 Wood Avenue South, Iselin, NJ, 08830, US

(73) Assignee: Siemens Medical Solutions Health Services Corporation

(21) Appl. No.: 10/222,371

(22) Filed: Aug. 16, 2002

Related U.S. Application Data
(60) Provisional application No. 60/360,185, filed on Feb. 27, 2002.

(51) Int. Cl. G06F 15/16

(52) U.S. Cl. 709/206; 709/203

(57) ABSTRACT

An apparatus and method for message communications addressing includes a system for addressing message communications to selected recipients, each of whom employ at least one of a plurality of disparate messaging services, the system including a messaging services database having different common address portion data elements associated with the corresponding disparate messaging services, and an interface processor for receiving and translating selected recipient identification information in accordance with the database to form communications addresses corresponding to each selected recipient; where the corresponding method for addressing message communications to selected recipients includes associating a username with at least one of the disparate messaging services, associating each of the disparate messaging services with a corresponding common address portion data element, selecting a username as a recipient of a message, translating the selected username into at least one corresponding messaging address in accordance with the associated messaging service and its corresponding common address portion data element, and transmitting the message to the corresponding messaging address for each selected recipient.

### CROSS-REFERENCE TO RELATED APPLICATION

This application claims benefit of U.S. Provisional Application No. 60/360,185 (Atty. Docket No. 02P03310US/8706-583), entitled “Address Directory System Supporting Message Communication,” filed Feb. 27, 2002.

### BACKGROUND

The present disclosure relates to electronic communications and, in particular, to a method and apparatus for addressing message communications. In typical message communications systems, a communications carrier receives incoming messages and transmits the messages to its own subscribers.

Unfortunately, each carrier generally has its own messaging system, and there is no consolidated system and related directory capability currently available. Email systems can provide the messaging function, but there is no simplified administration or end-user functionality associated with these systems. For example, each address for each device of each user must currently be entered manually by administrators and/or end-users. End-users must also retrieve or create individual address strings for each device of each recipient when sending a message. In addition, there is no mechanism for easy and structured creation and retrieval of an integrated address directory.

Accordingly, what is needed is a method and apparatus for addressing message communications to several subscribers of disparate messaging systems.

### SUMMARY

These and other drawbacks and disadvantages of the prior art are addressed by an apparatus and method for addressing message communications.

An apparatus for message communications addressing includes a system for addressing message communications to selected recipients, each of whom employ at least one of a plurality of disparate messaging services, the system including a messaging services database having different common address portion data elements associated with the corresponding disparate messaging services, and an interface processor for receiving and translating selected recipient identification information in accordance with the database to form communications addresses corresponding to each selected recipient.

A corresponding method for addressing message communications to selected recipients includes associating a username with at least one of the disparate messaging services, associating each of the disparate messaging services with a corresponding common address portion data element, selecting a username as a recipient of a message, translating the selected username into at least one corresponding messaging address in accordance with the associated messaging service and its corresponding common address portion data element, and transmitting the message to the corresponding messaging address for each selected recipient.

These and other aspects, features and advantages of the present disclosure will become apparent from the following description of exemplary embodiments, which is to be read in connection with the accompanying drawings.

### BRIEF DESCRIPTION OF THE DRAWINGS

The present disclosure teaches a method and apparatus for addressing message communications in accordance with the following exemplary figures, in which:

FIG. 1 shows a block diagram for a message communications addressing system according to an illustrative embodiment of the present disclosure;

FIG. 2 shows a block diagram for an addressable hand-held message communications apparatus usable in accordance with the system of FIG. 1;

FIG. 3 shows a block diagram for a messaging computer server usable in accordance with the system of FIG. 1;

FIGS. 4A and 4B show an Administrator's Text-Messaging Service Setup interface screen in accordance with FIG. 1;

FIG. 5 shows an Administrator's User Profile Setup interface screen in accordance with FIG. 1;

FIG. 6 shows an End-User Interface screen in accordance with FIG. 1; and

FIG. 7 shows an End-User Interface integrated with an exemplary Health Enterprise Dashboard screen in accordance with FIG. 1.

### DETAILED DESCRIPTION OF PREFERRED EMBODIMENTS

The present disclosure relates to electronic communications and, in particular, to a method and apparatus for addressing message communications. Embodiments of the present disclosure include messaging computer servers usable in message communications systems.

A preferred embodiment message communications addressing system comprises a web-based product that consolidates existing text messaging and short message service (“SMS”) services from wireless and paging carriers, and presents a simplified graphical user interface for practical everyday use by organizations on their intranet and/or Internet web sites.

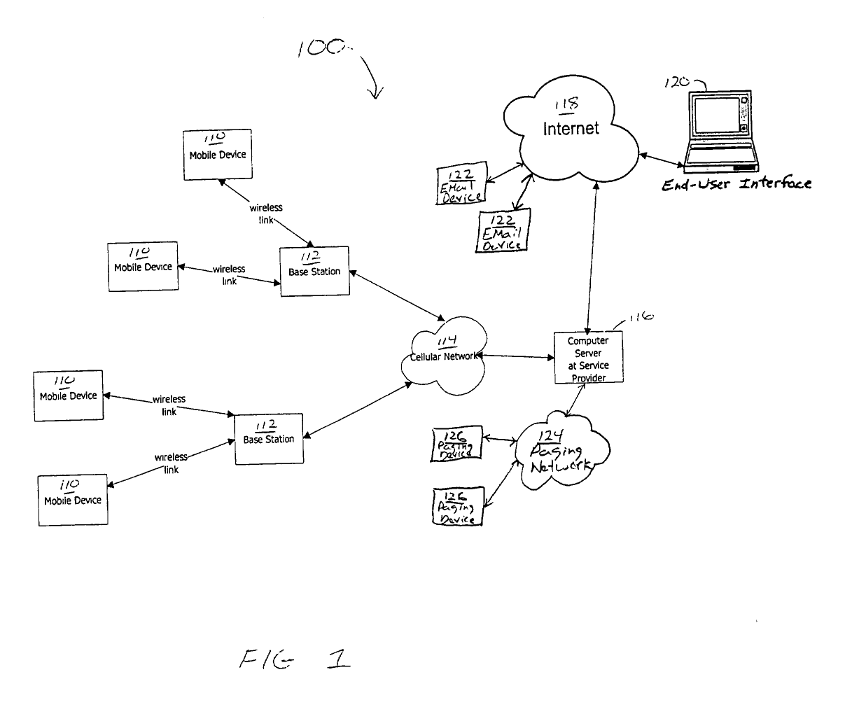

As shown in FIG. 1, a message communications system 100 includes addressable message communications devices 110, such as, for example, mobile cellular telephone embodiments. The addressable communications devices 110 are each connected in signal communication to a base station 112 via the customary wireless links. Each base station 112, in turn, is connected in signal communication with a cellular network 114. A computer server 116, such as, for example, a server residing with a messaging service provider, is connected in signal communication with the cellular network 114. The computer server 116 is further connected in signal communication with an internet 118.

An end-user interface 120 is connected in signal communication with the computer server 116 via the internet 118. The internet 118 is further coupled to email devices 122. The computer server 116 is further coupled to a paging network 124, which, in turn, is coupled to paging devices 126. Thus, a communications path is formed between the end-user interface 120 and the computer server 116, as well as from the end-user interface 120 to each of the mobile devices 110, the email devices 122 and the paging devices 126.

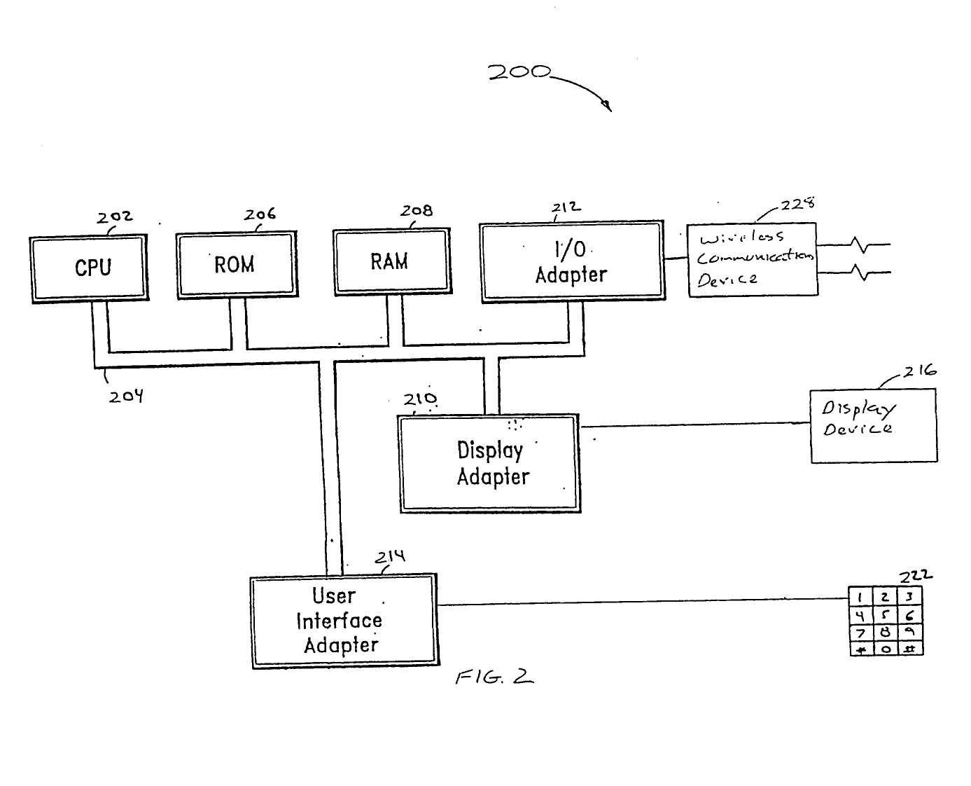

Turning to FIG. 2, an addressable message communications apparatus is generally indicated by the reference numeral 200. The addressable communications apparatus 200 may be embodied, for example, in a mobile cellular telephone according to embodiments of the present disclosure. The communications apparatus 200 includes at least one processor or Central Processing Unit (“CPU”) 202 in signal communication with a system bus 204. A Read Only Memory (“ROM”) 206, a Random Access Memory (“RAM”) 208, a display adapter 210, an Input/Output (“I/O”) adapter 212, and a user interface adapter 214 are also in signal communication with the system bus 204.

A display unit 216 is in signal communication with the system bus 204 via the display adapter 210, and a keypad 222 is in signal communication with the system bus 204 via the user interface adapter 214. The apparatus 200 also includes a wireless communications device 228 in signal communication with the system bus 204 via the I/O adapter 212, or via other suitable means as understood by those skilled in the art.

As will be recognized by those of ordinary skill in the pertinent art based on the teachings herein, alternate embodiments of the communications apparatus 200 are possible. For example, alternate embodiments may store some or all of the data or program code in registers located on the processor 202.

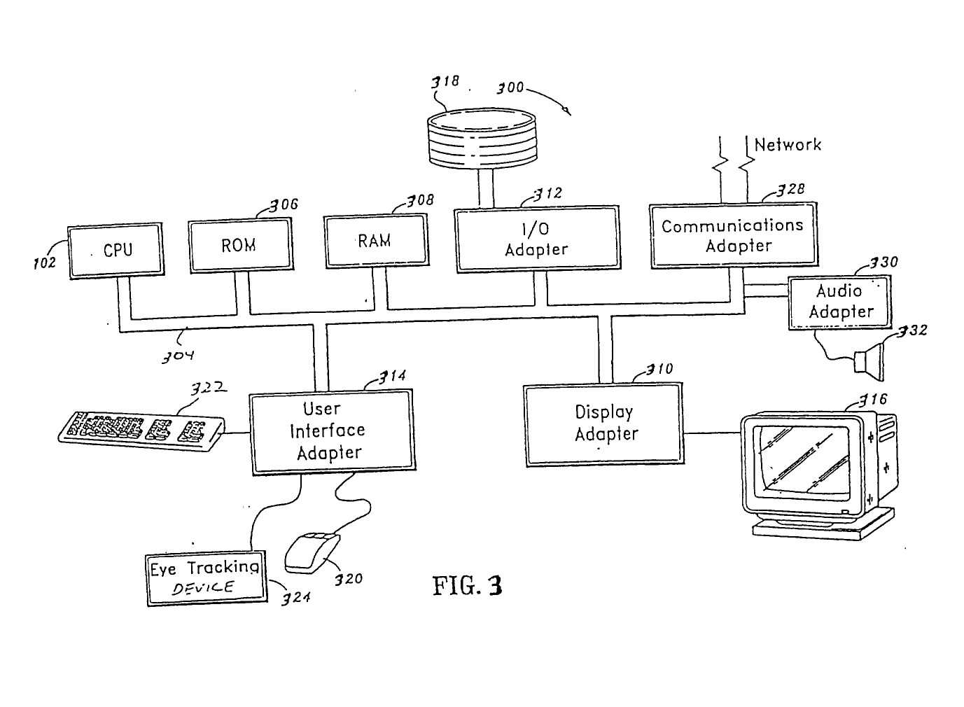

Turning now to FIG. 3, a messaging computer server is indicated generally by the reference numeral 300. The server 300 includes at least one processor or CPU 302 in signal communication with a system bus 304. A ROM 306, a RAM 308, a display adapter 310, an I/O adapter 312, and a user interface adapter 314 are also in signal communication with the system bus 304.

A display unit 316 is in signal communication with the system bus 304 via the display adapter 310. A data storage unit 318, such as, for example, a magnetic or optical disk storage unit or database, is in signal communication with the system bus 304 via the I/O adapter 312. A mouse 320, a keyboard 322, and an eye tracking device 324 are also in signal communication with the system bus 304 via the user interface adapter 314.

The server 300 also includes a communications adapter 328 in signal communication with the system bus 304, or via other suitable means as understood by those skilled in the art. The communications adapter 328 enables the exchange of data between the server 300 and a network, for example.

As will be recognized by those of ordinary skill in the pertinent art based on the teachings herein, alternate embodiments of the service provider computer server 300 are possible, such as, for example, embodying some or all of the computer program code in registers located on the processor chip 302. Given the teachings of the disclosure provided herein, those of ordinary skill in the pertinent art will contemplate various alternate configurations and implementations of elements of the server 300 while practicing within the scope and spirit of the present disclosure.

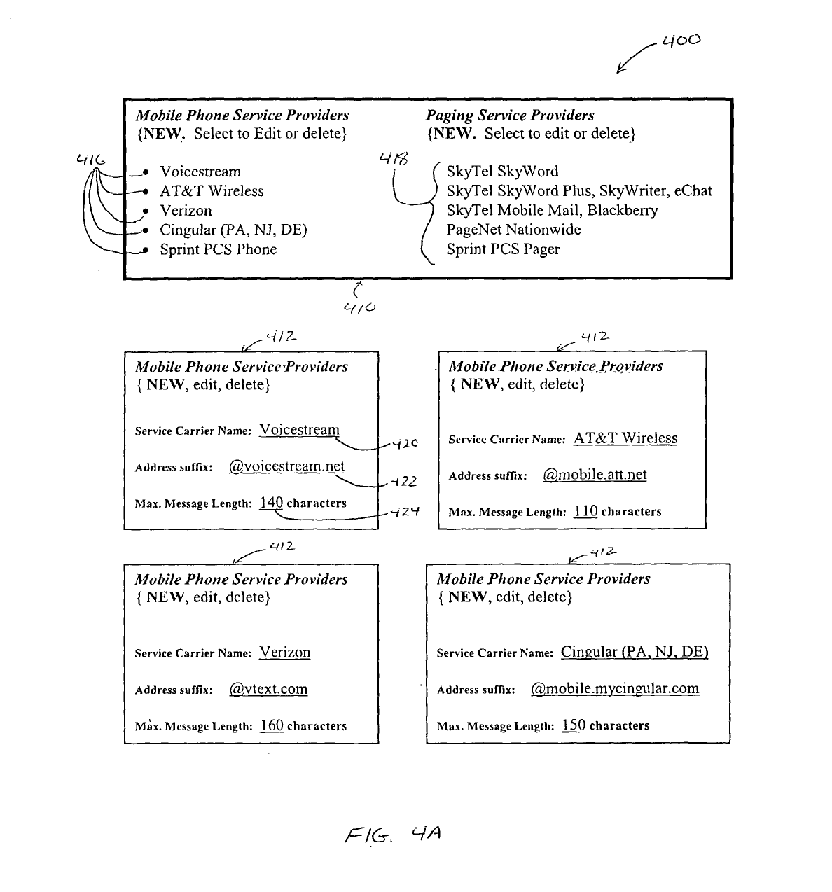

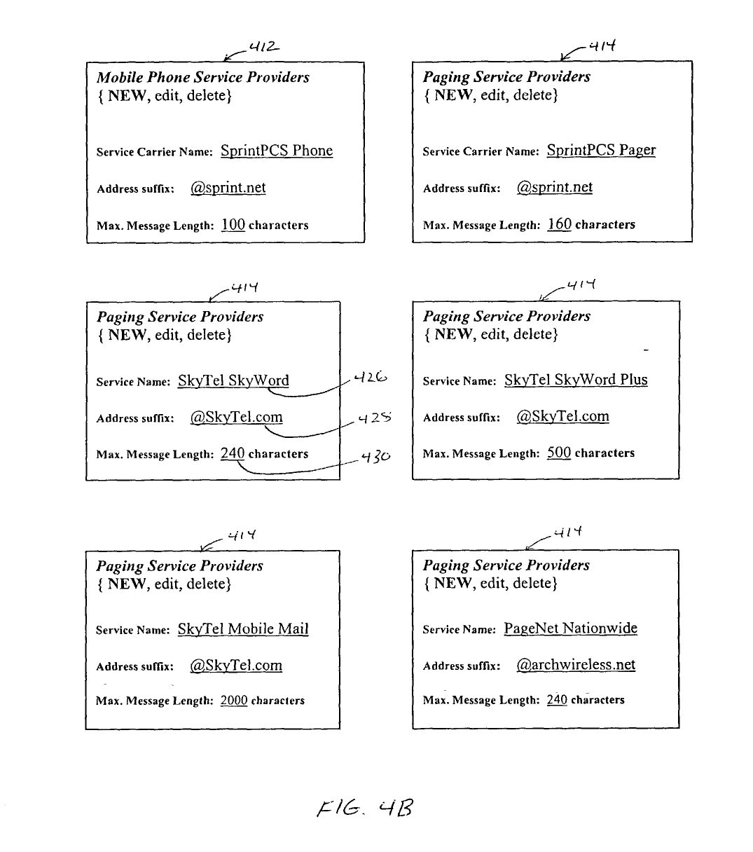

As shown in FIGS. 4A and 4B, an Administrator's Text-Messaging Service Setup interface screen is indicated generally by the reference numeral 400. The interface 400 includes a service provider directory block 410, several mobile phone service provider information blocks 412 and paging service provider information blocks 414. The service provider directory block 410 includes first entries 416 for mobile phone service providers, and second entries 418 for paging service providers. Any one of the entries 416 and 418 is individually selectable for editing or deleting. In addition, new entries may be made to the service provider directory block 410.

The mobile phone service provider information blocks 412 each include a service carrier name 420, an address suffix 422 and a maximum message length 424 permitted by that particular mobile phone carrier. Likewise, the paging service provider information blocks 414 each include a service carrier name 426, an address suffix 428 and a maximum message length 430 permitted by that particular paging carrier.

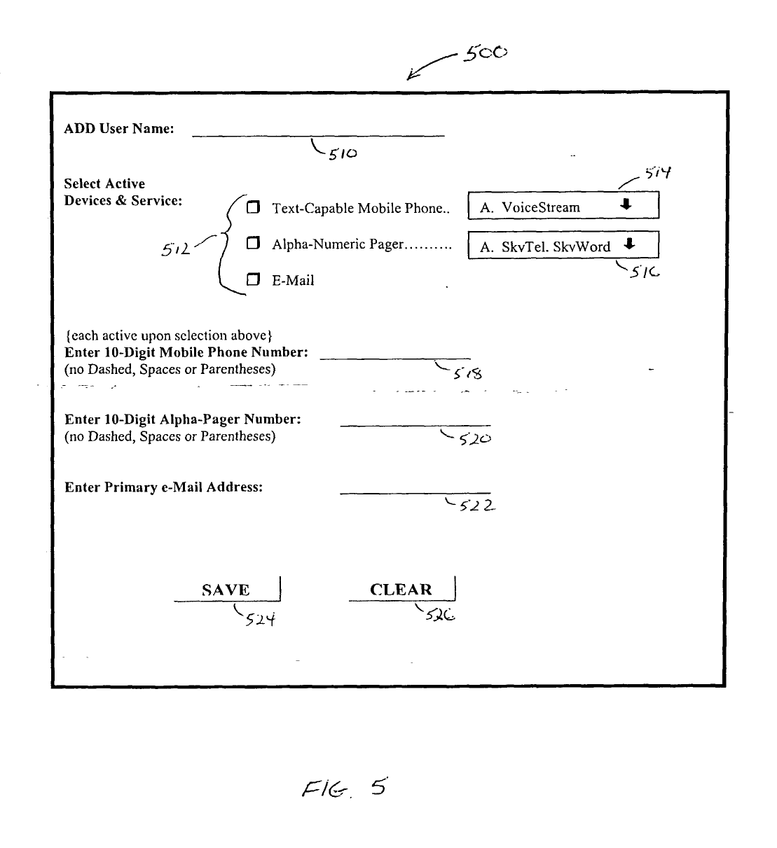

Turning to FIG. 5, an Administrator's User Profile Setup interface screen is indicated generally by the reference numeral 500. The Administrator's User Profile Setup interface screen 500 includes a user name field 510, a devices selection 512, a mobile phone carrier selection 514 and a paging carrier selection 516. The Administrator's User Profile Setup interface screen 500 further includes a mobile phone number field 518, an alphanumeric pager number field 520 and a user email address field 522. In addition, the interface screen 500 provides a save button 524 as well as a clear button 526 for saving or clearing, respectively, all fields and selections on the interface screen 500.

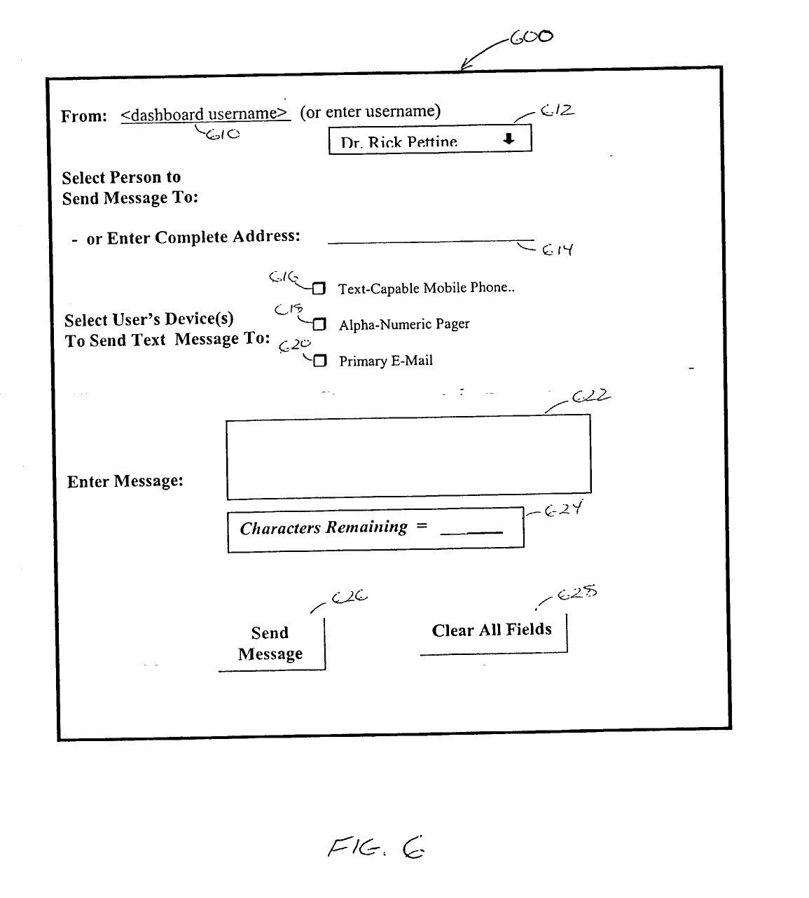

Turning now to FIG. 6, an End-User Interface screen is indicated generally by the reference numeral 600. The End-User Interface screen 600 includes a sender name field 610, a recipient name selection pull-down menu 612, and an optional manual address field 614. The interface screen 600 further includes a text-capable mobile phone selection box 616, an alphanumeric pager selection box 618 and an email selection box 620. A message box 622 is provided for entry of the message, while a character counter display box 624 displays the number of characters remaining before the lowest character limit of the selected mobile phone, pager and/or email is reached for at least one of the selected usernames. The interface screen 600 further provides a send message button 626 for sending the message and a clear all fields box 628 for clearing all entries and selections from the interface screen 600.

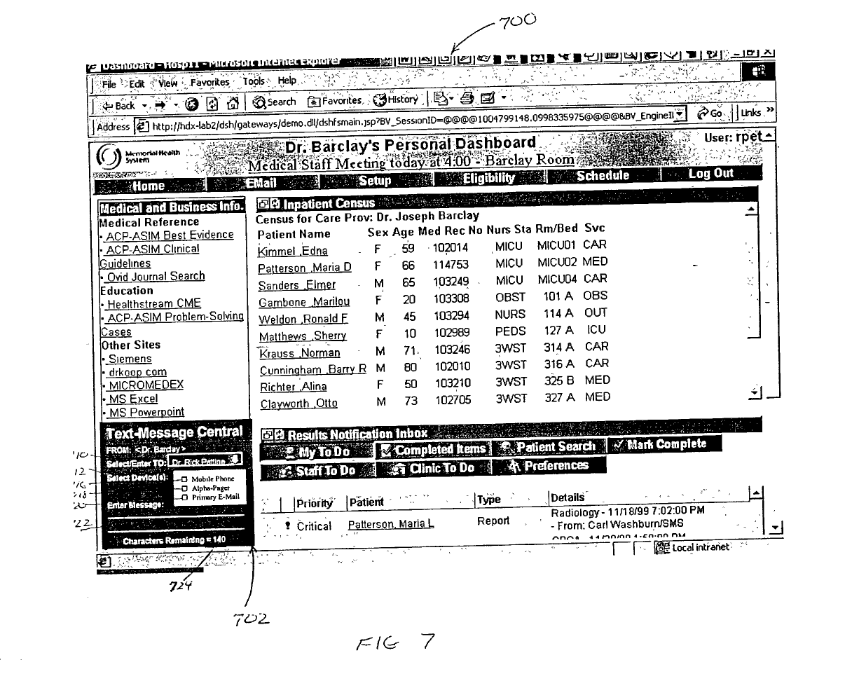

As shown in FIG. 7, an End-User Interface integrated with an exemplary Health Enterprise Dashboard screen is indicated generally by the reference numeral 700. The dashboard 700 includes an end-user interface portion 702. The interface portion 702 includes a sender name field 710 that is automatically filled with the name of the dashboard user in this exemplary embodiment. The interface portion 702 further includes a recipient name selection pull-down menu 712, a text-capable mobile phone selection box 716, an alphanumeric pager selection box 718 and an email selection box 720. A message box 722 is provided for entry of the message, while a character counter display box 724 displays the number of characters remaining before the lowest character limit of the selected mobile phone, pager and/or email is reached for at least one of the selected recipient usernames.

Thus, the present disclosure teaches a method and apparatus for addressing message communications. It shall be understood by those of ordinary skill in the pertinent art that embodiments of the present disclosure may be used in any messaging communications system. In particular, preferred embodiments are contemplated for use with cellular telephones, wireless pagers and internet email.

Exemplary embodiment message communications addressing systems are preferably structured as self-contained applets and/or plug-ins, which can be hosted on a central computer server or embedded into multiple web sites and/or application programs. The applets may also be used on personal mobile devices, such as, for example, devices running Windows CE or PocketPC 2000 operating systems.

In operation, the administrator is responsible for the initial population of the user directory with known service providers, as well as recipient's device and unique address representative numbers, such as, for example, an identification (“ID”) number or phone number.

Thus, to register messaging services, one step is to populate the system with a list of carrier and pager services, such as, for example, AT&T, VoiceStream, SkyTel, and the like that provide text messaging services. A default list is provided with the system. Each service profile registers the name, a suffix comprising the standard part of the Internet address that identifies the carrier and service to which messages are to be directed, and a maximum character limit for messages transmitted via each such service. The system is also usable for Internet based messaging services such as those of AOL, MSN and Yahoo, for example.

The administrator can add, edit, or delete users and their profile information. To add a user, the administrator enters the user's name as it is to appear for selection by the end-users. The devices that are available for messaging are selected for each user, and may include, for example, one or more of phone, pager, and/or email devices. For each device, a carrier and service is selected from a pull-down list, which has been created and/or maintained from the above-described service registration step. The list is only available, as may be indicated by highlighting or other suitable means as known in the art, if the device has been checked or selected. If the administrator is entering a list of users and comes across a user with a new carrier or service, the administrator can select “Add New” from the carrier/service list to be linked to the “Service Registration” function. Once a device and service is selected, the area field for entering the user specific phone number, pager number, and/or primary email address becomes active.

The end-user interface can be accessed in one or more of the following ways: as a standalone URL-based web application, as an embedded applet on an existing web site, or as an embedded function within an application. For the exemplary Health Enterprise Dashboard, this function is integrated into the personalized homepage of a Dashboard user. This integration streamlines the creation of the user profile and any fields required to be filled in by the end-user, such as, for example, the From and/or Message fields.

In particular embodiments, the end-user would first enter a From user name. For integrated systems such as for the Dashboard, for example, this field automatically defaults to the host system logon name. The end-user may override this default name in alternate embodiments.

The recipient is selected from a pull-down list. If the recipient is not in the list, or if the device is not registered in the system, the end-user can manually enter the entire recipient address, including the proper suffix for the targeted device. When a recipient is selected from the pull-down list, a list of devices for that specific recipient is presented, such as a phone, a pager, and/or an email. The end-user then selects the desired device(s) to which the message is to be sent. The interface processor 302 of FIG. 3 combines the recipient's user identification information with the common address portion data element of the messaging service corresponding to the selected device to form a user specific communications address.

For example, referring back to FIGS. 4B, 5 and 7, when Dr. Barclay completes a logon to the Dashboard application, Dr. Barclay's user identification information defaults to information corresponding to that derived in response to Dr. Barclay's Dashboard logon. Thus, Dr. Barclay need not reenter his/her own user identification information. When Dr. Barclay prepares a text message to Dr. Pettine in the “Text-Message Central” window 702, he/she might select Dr. Pettine's “Alpha-Pager” device checkbox 718. If Dr. Pettine's user identification information as entered in the user form 500 includes the alphanumeric pager service “SkyTel SkyWord” in box 516, and a pager or address representative number such as “8005551234” in box 520, then the number “8005551234” corresponding to Dr. Pettine's user identification information would be combined with the common address portion entered as the address suffix 428 in the paging service provider window 414 for “SkyTel SkyWord”. Thus, the address suffix 428 corresponding to the domain pointer “@SkyTel.com” would be combined to form the user specific communications address “8005551234@SkyTel.com”.

In some embodiments, the interface processor 302 of FIG. 3 may encrypt the user specific communications address so that such information may not be copied for use outside of the system. As will be recognized by those of ordinary skill in the pertinent art, a destination selection 620 of a primary email address may correspond to a user specific communications address such as a universal resource locator (“URL”), an internet protocol (“IP”) address, an address representative number and/or a domain name. Where the selected common address portion data element identifies an address portion as URL data beginning with an “@” symbol, the end string may include a typical end string, such as, for example, an ending of “.com”, “.net”, “.co”, “.biz”, “.info”, “.name”, a “.(country code)” string, and the like. In some embodiments, the “@” symbol of the common address portion data element may be omitted or excluded during entry and storage of the address suffix 422, and applied, if required, only at the time of combining the recipient's user identification information with the common address portion data element of the messaging service corresponding to the selected device to form a user specific communications address.

The end-user enters the message to be sent to the selected device(s). As the end-user enters the message, a countdown of characters remaining is shown. The countdown starts with the maximum message length value entered during service setup. If multiple devices are selected, the device with the lowest maximum message length value is used. If the end-user does not select a recipient from the list, but manually enters the entire address, “unknown” is displayed in the Characters Remaining field.

Thus, embodiments of the message communications addressing system provide a streamlined messaging system for front-ending any existing Internet-accessible text messaging service. The system may be employed in any industry with a desire to streamline text-messaging functionality to their constituents. For healthcare organizations, global portal sites, any web-based intranet or Internet web sites, or any application develop that desires to embed this messaging function, the function may be incorporated in a user interface application and ASP service. These and other embodiments provide a structured and simplified way for administrators to manage the online directory of users' text messaging devices, while providing the end-users with a consolidated directory and intuitive messaging system for communicating with their constituents.

Thus, a message communications addressing system is a single integrated system that provides text messaging and SMS communications utilizing multiple devices and service providers. Embodiments facilitate the entry and maintenance of online recipient directory entries by using “suffixes” of known services. Proper message addresses are identified by user and device, details of which are stored in an online directory. Preferred embodiments utilize existing carrier messaging services, gateways, and communication infrastructure accessible via the Internet, thereby eliminating the need to re-create and maintain multiple messaging infrastructures. An additional advantage is that system embodiments eliminate the need for the end-user to know the exact email address of the desired recipient's messaging device.

While not limited to healthcare, applicability in the healthcare enterprise system includes streamlined communication between physicians, nurses, emergency personnel, lab technicians, home health care specialists, and the like. Preferred embodiments are built with industry-standard technology, such as, for example, Java programming language applets, to be integrated into any web site, portal, application, mobile device or service. Preferred embodiments may be used under various operating systems including Microsoft Windows®, PocketPC®, WinCE® and wireless access protocol (“WAP”).

Thus, preferred embodiments for addressing message communications in accordance with the teachings of the present disclosure provide one access point for all text messaging systems by utilizing a single user directory that is customizable by the administrator. Such embodiments, which may be easily integrated into any intranet or Internet web site, include dynamic web page displays for device choices and parameters based upon previous user selections. In alternate embodiments, message communications addressing systems can integrate with existing email, LDAP and/or other directories to further reduce the number of user directories. In a preferred exemplary embodiment, this functionality is integrated with a Health Enterprise Dashboard user profile directory to reduce administrative data entry and account management.

These and other features and advantages of the present disclosure may be readily ascertained by one of ordinary skill in the pertinent art based on the teachings herein. It is to be understood that the teachings of the present disclosure may be implemented in various forms of hardware, software, firmware, special purpose processors, or combinations thereof.

The teachings of the present disclosure are preferably implemented as a combination of hardware and software. Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more Central Processing Units (“CPUs”), a Random Access Memory (“RAM”), and Input/Output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and an output unit.

It is to be further understood that, because some of the constituent system components and steps depicted in the accompanying drawings may be implemented in software, the actual connections between the system components or the process function blocks may differ depending upon the manner in which the present disclosure is programmed. Given the teachings herein, one of ordinary skill in the pertinent art will be able to contemplate these and similar implementations or configurations of the present disclosure.

Although illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope or spirit of the present disclosure. All such changes and modifications are intended to be included within the scope of the present disclosure as set forth in the appended claims.

What is claimed is:

1. A messaging communications system for addressing message communications to selected recipients, each of whom employ at least one of a plurality of disparate messaging services, the system comprising:
a messaging services database having a plurality of different common address portion data elements associated with the corresponding plurality of disparate messaging services; and
an interface processor for receiving and translating selected recipient identification information in accordance with the database to form at least one communications address corresponding to each selected recipient.

2. A system as defined in claim 1 wherein the message communications comprise alphanumeric text.

3. A system as defined in claim 1 wherein the disparate messaging services comprise at least one each of a cellular telephone network, a paging network and an email network.

4. A system as defined in claim 3 wherein the cellular telephone network comprises cellular telephones with text-messaging capabilities.

5. A system as defined in claim 3 wherein the paging network comprises a proprietary corporate network.

6. A system as defined in claim 3 wherein the email network comprises the Internet.

7. A system as defined in claim 1, further comprising an integrated dashboard application.

8. A method for addressing message communications to selected recipients, each of whom employ at least one of a plurality of disparate messaging services, the method comprising:
associating a username with at least one of the plurality of disparate messaging services;
associating each of the plurality of disparate messaging services with a corresponding common address portion data element;
selecting a username as a recipient of a message;
translating the selected username into at least one corresponding messaging address in accordance with the associated at least one messaging service and its corresponding common address portion data element; and
transmitting the message to the at least one corresponding messaging address for each selected recipient.

9. A method as defined in claim 8 wherein the message communications comprise alphanumeric text.

10. A method as defined in claim 8 wherein the disparate messaging services comprise at least one each of a cellular telephone network, a paging network and an email network.

11. A method as defined in claim 8 wherein the cellular telephone network comprises text-messaging capabilities.

12. A method as defined in claim 8 wherein the paging network comprises a proprietary corporate network.

13. A method as defined in claim 8 wherein the email network comprises the Internet.

14. A method as defined in claim 8, further comprising:
providing a dashboard;
receiving information from the provided dashboard; and
integrating the received information with the addressing of message communications.

15. An apparatus for addressing a messaging device, the apparatus comprising:
means for associating a username with at least one of the plurality of disparate messaging services;
means for associating each of the plurality of disparate messaging services with a corresponding common address portion data element;
means for selecting a username as a recipient of a message;
means for translating the selected username into at least one corresponding messaging address in accordance with the associated at least one messaging service and its corresponding common address portion data element; and
means for transmitting the message to the at least one corresponding messaging address for each selected recipient.

16. An apparatus as defined in claim 15, further comprising:
means for providing a dashboard;
means for receiving information from the provided dashboard; and
means for integrating the received information with the addressing of message communications.

17. A program storage device readable by machine, tangibly embodying a program of instructions executable by the machine to perform method steps for addressing a messaging device, the method steps comprising:
associating a username with at least one of the plurality of disparate messaging services;
associating each of the plurality of disparate messaging services with a corresponding common address portion data element;
selecting a username as a recipient of a message;
translating the selected username into at least one corresponding messaging address in accordance with the associated at least one messaging service and its corresponding common address portion data element; and
transmitting the message to the at least one corresponding messaging address for each selected recipient.

18. A program storage device as defined in claim 17, the method steps further comprising:
providing a dashboard;
receiving information from the provided dashboard; and
integrating the received information with the addressing of message communications.

19. A system for addressing a messaging device, the system comprising:
a communications network; and
a plurality of communications devices in signal communication with the communications network, wherein at least one of said communications devices comprises a messaging apparatus.

20. A system as defined in claim 19, the messaging apparatus comprising:
means for associating a username with at least one of the plurality of disparate messaging services;
means for associating each of the plurality of disparate messaging services with a corresponding common address portion data element;
means for selecting a username as a recipient of a message;
means for translating the selected username into at least one corresponding messaging address in accordance with the associated at least one messaging service and its corresponding common address portion data element; and
means for transmitting the message to the at least one corresponding messaging address for each selected recipient.

21. An address directory system supporting message communication between individual users employing a plurality of different communications services, the system comprising:
a database incorporating a plurality of different common address portion data elements associated with a corresponding plurality of different messaging services; and
an interface processor for,
receiving user identification information, and
combining said user identification information with a selected common address portion data element of a corresponding message service to form a user specific communication address using said corresponding messaging service.

22. A system according to claim 21, wherein said user specific communication address comprises at least one of, (a) a universal resource locator (“URL”), (b) an internet protocol (“IP”) address, (c) an address representative number and (d) a domain name.

23. A system according to claim 22, wherein said user specific communication address comprises a single URL data string.

24. A system according to claim 21, wherein said interface processor interprets received user identification information to provide a user specific address portion and combines said user specific address portion with a selected common address portion data element of a corresponding message service to form a user specific communication address using said corresponding messaging service.

25. A system according to claim 21, wherein said interface processor encrypts said user specific communication address.

26. A system according to claim 21, wherein said received user identification information comprises default information derived in response to user logon to an application.

27. A system according to claim 21, wherein said interface processor identifies said selected common address portion data element in said database incorporating different common address portion data elements in response to received message service identification information.

28. A system according to claim 27, wherein said received message service identification information identifies at least one of, (a) a phone based messaging service, (b) a pager based messaging service, (c) an Email based messaging service and (d) an Internet based messaging service.

29. A system according to claim 21, wherein said selected common address portion data element identifies said address portion as URL data beginning with an @ symbol and ending with at least one of, (a) a “.com” string, (b) a “.net” string, (c) a “.co” string, (d) a “.“country code”” string, (e) a “.biz” string, (f) an “.info” string and (g) a “.name” string.

30. A system according to claim 29, wherein said selected common address portion data element excludes said @ symbol.

31. A system according to claim 21, wherein said database incorporates data identifying a maximum text string length associated with individual services of said plurality of different messaging services.

32. A system according to claim 21, including a communication processor for receiving text message data for forwarding to said user specific communication address and for comparing said received text message data with a predetermined maximum text string length limit.

33. A method for providing a user interface supporting message communication between individual users employing a plurality of different communication services, comprising:
initiating generation of data representing at least one displayed image supporting,
selecting a message recipient using a directory identifying a plurality of candidate message recipients, said directory associating said plurality of candidate message recipients with a plurality of different common address portion data elements associated with a corresponding plurality of different messaging services;
user entry of a message for communication to said selected message recipient; and
initiating communication of a user entered message to said selected message recipient using an associated messaging service identified from said plurality of different messaging services at a user specific communication address derived using an associated common address portion data element identified using said directory.

34. A method according to claim 33, including the steps of:
receiving user identification information, and
combining said user identification information with said associated common address portion to form said derived user specific communication address.

35. A method according to claim 33, wherein said directory associates said plurality of different messaging services with a corresponding plurality of predetermined maximum text string length limit values and including the step of comparing received text message data with a predetermined maximum text string length limit value identified using said directory.

36. A method according to claim 33, wherein said at least one displayed image supports receiving message service identification information for use in selecting said associated common address portion data element.

37. A method according to claim 36, wherein said received message service identification information identifies at least one of, (a) a phone based messaging service, (b) a pager based messaging service, (c) an Email based messaging service and (d) an Internet based messaging service.

38. An address directory system supporting message communication between individual users employing a plurality of different communication services, comprising:
a database incorporating a plurality of different common address portion data elements associated with a corresponding plurality of different messaging services; and
an interface processor for,
receiving user identification information, and
combining said user identification information with a selected common address portion data element of a corresponding message service to form a user specific communication address using said corresponding messaging service; and
a communication processor for receiving text message data for forwarding to said user specific communication address.

39. A system according to claim 38, wherein
said database associates said plurality of different messaging services with a corresponding plurality of predetermined maximum text string length limit values and
said communication processor compares received text message data with a predetermined maximum text string length limit value identified using said database.

40. A method for providing an address directory system supporting message communication between individual users employing a plurality of different communication services, comprising the steps of:
associating a plurality of different common address portion data elements with a corresponding plurality of different messaging services;
receiving user identification information; and
combining said user identification information with a selected common address portion data element of a corresponding message service to form a user specific communication address using said corresponding messaging service.
